(19) United States
(12) Patent Application Publication
(10) Pub. No.: US 2008/0203930 A1
(43) Pub. Date: Aug. 28, 2008

(54) Electroluminescent Display Devices

(75) Inventors: Franciscus P.M. Budzelaar, Eindhoven (NL); Martin Hiddink, 's-Hertogenbosch (NL); David A. Fish, Haywards Heath (GB); Mark J. Childs, Swindon (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,779

(22) PCT Filed: May 16, 2006
(86) PCT No.: PCT/IB2006/051542

§ 371 Date: Nov. 19, 2007

(30) Foreign Application Priority Data
May 19, 2005 (EP) 05104273.7

(51) Int. Cl. G09G 3/10; G09G 3/30

(52) U.S. Cl. 315/169.1; 345/76

(57) ABSTRACT

An active matrix display device comprises an array of display pixels provided over a common substrate. Each pixel has a voltage-programmed current source circuit, a drive transistor and a light sensitive device for sensing the display element light output. The light sensitive device provides a current dependent on the display element output, and the light sensitive device and the current source circuit define a feedback control loop which controls the voltage provided to the gate of the drive transistor. This pixel circuit uses a current source circuit to provide a gate voltage to a drive transistor. This enables the current source circuit to operate at low current levels, and therefore under low voltage stress.

This invention relates to electroluminescent display devices, particularly active matrix display devices having an array of pixels comprising light-emitting electroluminescent display elements and thin film transistors. More particularly, but not exclusively, the invention is concerned with an active matrix electroluminescent display device whose pixels include light sensing elements which are responsive to light emitted by the display elements and used in the control of energisation of the display elements.

Matrix display devices employing electroluminescent, light-emitting, display elements are well known. The display elements commonly comprise organic thin film electroluminescent elements, (OLEDs), including polymer materials (PLEDs), or else light emitting diodes (LEDs). The term LED used below is intended to cover all of these possibilities. These materials typically comprise one or more layers of a semiconducting conjugated polymer sandwiched between a pair of electrodes, one of which is transparent and the other of which is of a material suitable for injecting holes or electrons into the polymer layer.

The display elements in such display devices are current driven and a conventional, analogue, drive scheme involves supplying a controllable current to the display element. Typically, a current source transistor is provided as part of the pixel configuration, with the gate voltage supplied to the current source transistor determining the current through the electroluminescent (EL) display element. A storage capacitor holds the gate voltage after the addressing phase. An example of such a pixel circuit is described in EP-A-0717446.

Each pixel thus comprises the EL display element and associated driver circuitry. The driver circuitry has an address transistor which is turned on by a row address pulse on a row conductor. When the address transistor is turned on, a data voltage on a column conductor can pass to the remainder of the pixel. In particular, the address transistor supplies the column conductor voltage to the current source, comprising the drive transistor and the storage capacitor connected to the gate of the drive transistor. The column, data, voltage is provided to the gate of the drive transistor and the gate is held at this voltage by the storage capacitor even after the row address pulse has ended. The drive transistor can be implemented as a p-channel TFT, (Thin Film Transistor) so that the storage capacitor holds the gate-source voltage fixed. This results in a fixed source-drain current through the transistor, which therefore provides the desired current source operation of the pixel. The brightness of the EL display element is approximately proportional to the current flowing through it.

In the above basic pixel circuit, differential ageing, or degradation, of the LED material, leading to a reduction in the brightness level of a pixel for a given drive current, can give rise to variations in image quality across a display. A display element that has been used extensively will be much dimmer than a display element that has been used rarely. Also, display non-uniformity problems can arise due to the variability in the characteristics of the drive transistors, particularly the threshold voltage level.

Improved voltage-addressed pixel circuits which can compensate for the ageing of the LED material and variation in transistor characteristics have been proposed. These include a light sensing element which is responsive to the light output of the display element and acts to leak stored charge on the storage capacitor in response to the light output so as to control the integrated light output of the display element during the drive period which follows the initial addressing of the pixel. Examples of this type of pixel configuration are described in detail in WO 01/20591 and EP 1 096 466. In an example embodiment, a photodiode in the pixel discharges the gate voltage stored on the storage capacitor and the EL display element ceases to emit when the gate voltage on the drive transistor reaches the threshold voltage, at which time the storage capacitor stops discharging. The rate at which charge is leaked from the photodiode is a function of the display element output, so that the photodiode serves as a light-sensitive feedback device.

The optical feedback arrangement enables compensation for initial non-uniformity between TFTs and display elements, as well as changes in these non-uniformities over time. The light output from a display element is independent of the EL display element efficiency and ageing compensation is thereby provided. Such a technique has been shown to be effective in achieving a high quality display which suffers less from non-uniformities over a period of time. However, this method requires a high instantaneous peak brightness level to achieve adequate average brightness from a pixel in a frame time and this is not beneficial to the operation of the display as the LED material is likely to age more rapidly as a result.

In an alternative approach, the optical feedback system is used to change the duty cycle with which the display element is operated. The display element is driven to a fixed brightness, and the optical feedback is used to trigger a transistor switch which turns off the drive transistor rapidly. This avoids the need for high instantaneous brightness levels, but introduces additional complexity to the pixel.

The use of optical feedback systems is considered as an effective way of overcoming differential ageing of the LED display elements.

These known techniques enable accurate and reproducible conversion of the programmed voltage to the desired display element light output, with compensation for threshold voltage shift in the amorphous silicon transistors, and with insensitivity to degradation of the light emitting materials

There is still a need for a circuit which meets these requirements and with simple drive electronics as well as low complexity pixel design.

According to the invention, there is provided an active matrix display device comprising an array of display pixels provided over a common substrate, each pixel comprising:

a voltage-programmed current source circuit;

a drive transistor;

a current-driven light emitting display element driven by the drive transistor; and

a light sensitive device for sensing the display element light output,

wherein the light sensitive device provides a current dependent on the display element output, and wherein the light sensitive device and the current source circuit define a feedback control loop which controls the voltage provided to the gate of the drive transistor.

This pixel circuit uses a current source circuit to provide a gate voltage to a drive transistor. This enables the current source circuit to operate at low current levels, and therefore under low voltage stress. A drive transistor in the current source circuit will therefore undergo small threshold voltage drift, and can be used as an accurate current source over prolonged periods. The level of current to be sourced by the current source circuit is proportional to the current output of the light sensitive device (for example photodiode).

Preferably, there is a subtraction between the current source output and the photodiode current, so that a difference signal is used as a feedback control signal, and this difference signal is brought to zero in the stabilized condition.

The transfer characteristic of the pixel is determined by the current source circuit, and if a single stage transistor is used, this corresponds to a gamma of 2 (because the output current is proportional to the square of the gate-source voltage). This provides good low grey scale reproduction.

The current source circuit preferably comprises a current source transistor, and further comprises a data storage capacitor for holding a gate voltage of the current source transistor. This provides the current source operation of the transistor. The data storage capacitor is preferably provided between the gate and source of the current source transistor.

The feedback control loop can be arranged to control the drive transistor gate voltage such that the light sensitive device current and the current source circuit output current are equal. The feedback loop thus controls the drive transistor until the light output gives rise to a corresponding light sensitive element output. This feedback thus overcomes any threshold voltage drift in the drive transistor and degradation of the display element output, as the feedback is based on the light output.

Each pixel may instead further comprise a second light sensitive element, and the feedback control loop is then arranged to control the drive transistor gate voltage such that the difference between the light sensitive device currents and the current source circuit output current are equal. This second light sensitive element then provides compensation for ambient light levels. The first and second light sensitive elements each preferably comprise substantially identical photodiodes, and the second light sensitive element is exposed to ambient light but is shielded from the display element light output.

In another arrangement, the current source circuit further comprises a second storage capacitor, with the data storage capacitor and the second storage capacitor in series between the gate and source of the current source transistor. This second storage capacitor can then be used to store a voltage derived from the light sensitive device output for ambient light conditions.

The invention also provides a method of driving an active matrix display device comprising an array of display pixels provided over a common substrate, comprising, for each pixel:

driving one end of a data storage capacitor to a reference voltage;

driving the other end of the data storage capacitor to a data voltage;

driving a current source circuit using the voltage across the data storage capacitor;

using the current source circuit output to change the gate voltage of a drive transistor, and thereby to turn on a light emitting display element;

sensing the display element light output using a light sensitive device which provides a current dependent on the display element output; and

combining the light sensitive device current and the current source circuit current to control the voltage provided to the gate of the drive transistor.

Examples of the invention will now be described in detail with reference to the accompanying drawings, in which:

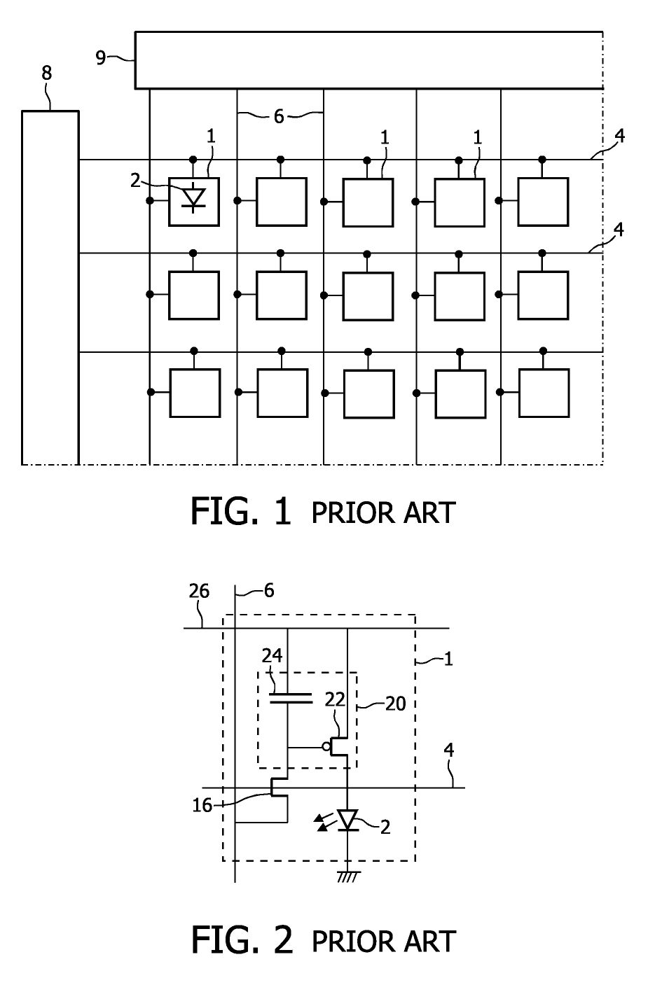

FIG. 1 is a simplified schematic diagram of an embodiment of active matrix EL display device;

FIG. 2 illustrates a known form of pixel circuit;

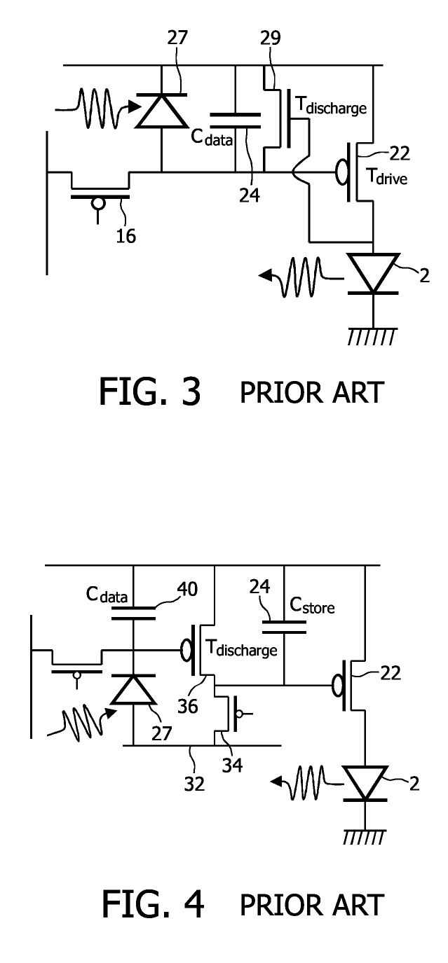

FIG. 3 shows a first known optical feedback pixel design;

FIG. 4 shows a second known optical feedback pixel design;

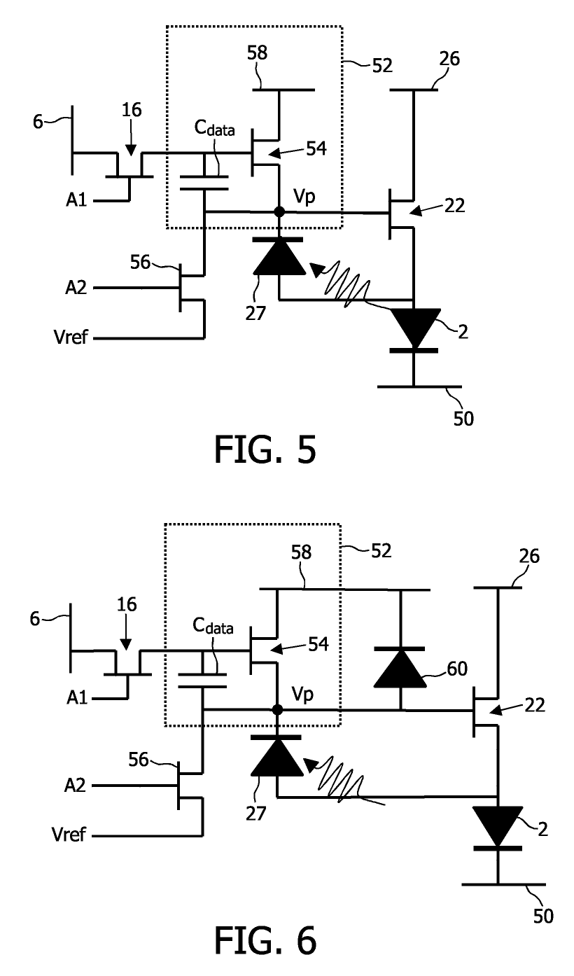

FIG. 5 shows a first example of pixel circuit of the invention;

FIG. 6 shows a second example of pixel circuit of the invention; and

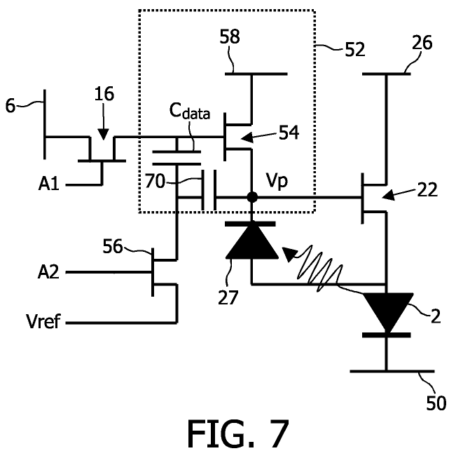

FIG. 7 shows a third example of pixel circuit of the invention.

The same reference numbers are used throughout the Figures to denote the same or similar parts.

FIG. 1 shows a known active matrix electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) conductors 4 and 6. Only a few pixels are shown in FIG. 1 for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support.

FIG. 2 shows in simplified schematic form the most basic pixel and drive circuitry arrangement for providing voltage-addressed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

The drive transistor 22 in this circuit is implemented as a p-type TFT, so that the storage capacitor 24 holds the gate-source voltage fixed. This results in a fixed source-drain current through the transistor, which therefore provides the desired current source operation of the pixel.

In the above basic pixel circuit, for circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

FIGS. 3 and 4 show examples of pixel layout with optical feedback to provide ageing compensation.

In the pixel circuit of FIG. 3, a photodiode 27 discharges the gate voltage stored on the capacitor 24 (C_{data}), causing the brightness to reduce. The display element 2 will no longer emit when the gate voltage on the drive transistor 22 (T_{drive}) reaches the threshold voltage, and the storage capacitor 24 will then stop discharging. The rate at which charge is leaked from the photodiode 27 is a function of the display element output, so that the photodiode 27 functions as a light-sensitive feedback device. Once the drive transistor 22 has switched off, the display element anode voltage reduces causing the discharge transistor 29 (T_{discharge}) to turn on, so that the remaining charge on the storage capacitor 24 is rapidly lost and the luminance is switched off.

As the capacitor holding the gate-source voltage is discharged, the drive current for the display element drops gradually. Thus, the brightness tails off. This gives rise to a lower average light intensity.

FIG. 4 shows a circuit which has been proposed by the applicant, and which has a constant light output and then switches off at a time dependent on the light output.

The gate-source voltage for the drive transistor 22 is again held on a storage capacitor 24 (Cₛₜₒᵣₑ). However, in this circuit, this capacitor 24 is charged to a fixed voltage from a charging line 32, by means of a charging transistor 34. Thus, the drive transistor 22 is driven to a constant level which is independent of the data input to the pixel when the display element is to be illuminated. The brightness is controlled by varying the duty cycle, in particular by varying the time when the drive transistor is turned off.

The drive transistor 22 is turned off by means of a discharge transistor 36 which discharges the storage capacitor 24. When the discharge transistor 36 is turned on, the capacitor 24 is rapidly discharged and the drive transistor turned off.

The discharge transistor 36 is turned on when the gate voltage reaches a sufficient voltage. A photodiode 27 is illuminated by the display element 2 and again generates a photocurrent in dependence on the light output of the display element 2. This photocurrent charges a discharge capacitor 40 (C_{data}), and at a certain point in time, the voltage across the capacitor 40 will reach the threshold voltage of the discharge transistor 36 and thereby switch it on. This time will depend on the charge originally stored on the capacitor 40 and on the photocurrent, which in turn depends on the light output of the display element. The discharge capacitor initially stores a data voltage, so that both the initial data and the optical feedback influence the duty cycle of the circuit.

There are many alternative implementations of pixel circuit with optical feedback. FIGS. 3 and 4 show p-type implementations, and there are also n-type implementations, for example for amorphous silicon transistors.

FIG. 5 shows a first example of the pixel circuit of the invention, implemented using n-type transistors. The circuit is thus suitable for implementation using amorphous silicon transistors.

As in the circuits of FIGS. 2 to 4, a drive transistor 22 and the current-driven light emitting display element 2 are in series between power lines 26, 50. An address transistor 16 is provided between a data input 6 to the pixel and the pixel circuit input.

The circuit comprises a voltage-programmed current source circuit 52, but using a current source circuit transistor 54 which is not the drive transistor. This transistor 54 therefore does not drive the load of the display element.

A photodiode 27 again senses the display element light output, and provides a current dependent on the display element output. The current of the current source circuit 52 and the photodiode flow to a common node Vp. The circuit is designed to implement a feedback control loop which controls the voltage provided to the gate of the drive transistor. In particular, the node Vp is connected to the gate of the drive transistor 22. When the two currents to the node are equal, the voltage on the node Vp has stabilized, and the feedback loop has reached its equilibrium. This equilibrium defines the operating point of the drive transistor 22.

This enables the current source circuit 52 to operate at low current levels, and therefore under low voltage stress. The current source transistor 54 therefore undergoes small threshold voltage drift, and can be used as an accurate current source over prolonged periods.

The data storage capacitor C_{data} is provided between the gate and source of the current source transistor 54.

A reset transistor 56 is provided between a reference voltage source Vref and the gate of the drive transistor 22 (which is connected to the source of the current source transistor 54). This enables the voltage on one side of the data storage capacitor C_{data} to be fixed so that a precisely known data voltage can be stored across the capacitor in a pixel programming step.

The transfer characteristic of the pixel (namely the relationship between the data input and the brightness output) is determined by the current source circuit, and in particular the voltage-current response of the transistor 54. This corresponds to a gamma of 2, because the output current is proportional to the square of the gate-source voltage (over threshold). This provides good low grey scale reproduction.

The feedback control alters the brightness until a selected current flows through the photodiode. This feedback thus overcomes any threshold voltage drift in the drive transistor 22 and degradation of the display element output, as the feedback is based on the light output.

The operation of the circuit of FIG. 5 will now be explained in more detail.

An addressing (programming) step involves accurately storing a voltage of the capacitor C_{data} which will give a current source circuit output corresponding to the desired photodiode current.

To achieve this, the reset transistor 56 is turned on, and this drives the node Vp to the reference voltage Vref. This reference voltage ensures that the drive transistor 22 is turned off, so that no light is generated. The node Vp is then held at a stable reference voltage to enable charging of the data capacitor C_{data}.

The grey level pixel data is then applied to the data line 6, and this data voltage is referenced to the reference voltage Vref. The address transistor 16 is turned on to store the desired voltage on the data capacitor.

The address transistor 16 is then turned off so that the voltage on the data capacitor C_{data} is fixed.

The gate source voltage of the current source transistor 54 is then stable. In the operating range over which the current source transistor 54 will be operated, this voltage gives rise to a drain source current (Ids) defined by the equation:

$$Ids = \frac{{μ}_{n} {ɛ}_{ox}}{2 {t}_{ox}} \frac{W}{L} {( {V}_{gs} - {V}_{t} )}^{2}$$

This current is proportional to the square of the gate source voltage, giving the gamma characteristic of 2, as mentioned above.

During the pixel address/programming stage, a current is drawn through the current source transistor 54, and this sinks to the reference voltage line.

The address/programming step is completed by turning off the reset transistor 56, and thereby decoupling the reference voltage Vref from the node Vp.

After the addressing phase, light is generated. At the beginning of this phase, the voltage of the node Vp is still the reference voltage Vref, which has been selected such that the drive transistor 22 not conducting, and no light is initially generated. The current source transistor 54 however conducts, and a current flows into the node Vp. The voltage at the node Vp increases very quickly, and eventually the drive transistor 22 starts conducting.

The current through the display element 2 causes light to be generated. Part of the light hits the photodiode 27, which generates a current proportional to the received light. This will counteract the current source circuit current, and thereby slow the increase in voltage on the node Vp.

After a short period, a stable situation will be reached, in which the current delivered by the current source circuit 52 (which is still the current as defined by the programming voltage) and the current through the photodiode 27 (defined by the received light) are equal, and the voltage on the node Vp will stabilise.

This circuit thus provides an optical feedback control circuit with only two address lines (labeled A1 and A2) and a single additional transistor for the feedback control. Two address lines is the minimum required to implement the three address phases of addressing, pixel on and pixel off. The characteristics of the pixel circuit are determined by the current source transistor which can be accurately designed, and this is operated at low gate-source voltage levels, so that it does not suffer high voltage stress. In particular, the characteristics are determined by the threshold voltage and mobility of the current source transistor.

In the pixel circuit, there are only four n-type TFTs, one capacitor and one photodiode. Only one of the TFTs must be able to carry a large current and needs to be relatively large, and the other transistors can all be very small.

The circuit is also able to tolerate fluctuations of the power line voltages, as these have little influence on the light output. The only critical voltage is the reference voltage Vref, during the programming phase.

A number of modifications to this circuit can be made without affecting the function or performance.

A photosensitive TFT can be used instead of the photodiode shown.

In the example of FIG. 5, the current source circuit 52 is shown having its own power line 58, but this may be connected to the main power line 26, or it can be a separate power supply line. There are advantages to the separate power lines 26,58 shown for power consumption. Indeed, a separate current source power line 58 may be used for each colour. The voltage across the display elements differ significantly, and the drain-source voltage of the drive transistor 22 must be minimised to reduce dissipation. The voltage of power line 58 should ideally be somewhat higher than the voltage on the power line 26 so that the current source transistor can operate in its saturated region (with V_{GS}-Vₜ less than or equal to the drain source-voltage), and the drain current is then substantially independent of the drain-source voltage, and determined solely by the gate-source voltage.

The reference voltage Vref may also be connected to the cathode line 50 or may be an independent reference line.

The pixel circuit enables duty cycle control to be introduced (which is a known measure for improving motion rendition). The reset transistor 56 can be used for this purpose. By switching on the reset transistor 56 before the end of the field period, the voltage on the node Vp can be reduced quickly to the reference voltage Vref, and the pixel is thus turned off. The current source output current then flows through the reset transistor 56 to the reference voltage line.

A critical design parameter is the ratio between display element current and the photodiode (or phototransistor) current. For energy efficiency reasons, the photodiode current must be kept as low as possible. However, a reduction in this photodiode current results in a longer period to stabilize the voltage on node Vp.

The most critical aspect in the dimensioning of the various elements of the circuit is the photodiode. Typical photodiodes have a very low light to current conversion ratio, resulting in extremely low currents. The current source transistor carries currents of the same magnitude, and the photodiode therefore needs to be designed to operate the transistor 54 in a suitable range. In particular, the transistor 54 should be operated in the sub-threshold voltage region, to provide sufficiently low current and to avoid drift. Substantial drift occurs for operation above threshold.

The circuit design above relies on the low voltage stress of the current source transistor to avoid threshold voltage drift of that transistor. It also assumes the optical feedback functions correctly. Refinements to the circuit are described below which address these issues.

FIG. 6 shows a second example of circuit. The same reference numbers are used and the circuit operates with the same steps.

An additional photodiode 60 is provided in parallel with the current source transistor 54 and this is arranged to compensate for ambient light. The photodiode 60 is identical to the photodiode 27, and thereby has the same properties. The photodiode 60 is placed outside the view of the light emitting area. Both photodiodes 27,60 behave in the same way under ambient light variations. This means that the total photocurrent of the photodiode 27 is no longer balanced, but only the part originating from the display element output. This improves the feedback mechanism.

The circuit of FIG. 6 gives real time correction of the ambient light, and can tolerate fast variations of ambient light. There is still no correction of threshold variations of the current source transistor, and one further possible issue is that the second photodiode uses pixel aperture because it must only be exposed to the ambient light.

FIG. 7 shows a second example of circuit. Again, the same reference numbers are used and the circuit operates with the same basic principles.

This circuit compensates for ambient light as well as threshold variations of the current source transistor 54.

The circuit includes a second capacitor storage capacitor 70, with the data capacitor C_{data} and the second storage capacitor 70 in series between the gate and source of the current source transistor 54. The reset transistor 56 is connected to the junction between the data capacitor C_{data} and the second storage capacitor 70, so that the programming of data into the pixel is to the data capacitor only. The second capacitor 70 is for storing a voltage derived from the light sensitive device output for ambient light conditions.

A modified method operation of the circuit enables the circuit to compensate for threshold voltage variations as well as ambient light conditions.

During the pixel programming step, with the address transistor 16 and the reset transistor 56 turned on, the reference voltage V_{ref} is applied to one end of the data capacitor C_{data} and a data voltage corresponding to a black output (V_{data}=V_{black}) is applied. As before, the data voltage is sufficiently low to ensure that the drive transistor 22 does not supply a current through the display element 2. This requirement is fulfilled when V_{data}-Vₜ₍₅₄₎ is below the onset of the drive transistor 22, where Vₜ₅₄) is the threshold voltage of the current source transistor 54.

If the current through the transistor 54 is higher than the photocurrent, the second storage capacitor 70 will charge and therewith the voltage at the source of transistor 54 will rise. Similarly, if the current through the transistor 54 is lower than the photocurrent, the second storage capacitor 70 will discharge and therewith the voltage at the source of transistor 54 will fall.

Since the gate of the transistor 54 is at a fixed voltage, this results in a decreasing or increasing gate source voltage, and therewith a change in the current source output current. This process implements a feedback control loop which continues until the current source output current is equal to the photocurrent, corresponding to the black drive level. As a result, an offset voltage corresponding to the photocurrent in the dark state, including the offset, is stored in the series capacitor arrangement. The data capacitor C_{data} stores the black state pixel drive level, and the second capacitor stores the offset which compensates for ambient light as well as taking account of the threshold voltage of the current source transistor.

The data voltage is then changed by ΔV, and this results in the gate source voltage of the current source transistor 54 being set exactly ΔV above the previously defined offset in threshold and dark current.

The circuit will continue to balance the current source transistor current and the photocurrent, and this takes place after the address and reset transistors are turned off, immediately after applying the desired voltage step change ΔV at the data line 6.

The gate source voltage of the current source transistor is held constant by the floating capacitor arrangement, and so the current is fixed (at a current higher than the photo current). As in the previous circuits, the voltage at the node Vp increases, and the display element will start emitting light, giving an increased photocurrent. Again, the circuit stabilises when the photocurrent is increased to the output of the current source circuit.

The circuit of FIG. 7 does not result in any aperture loss (particularly for top emitting structures). An additional addressing step is required to measure the dark state offset, and the timing of the driving signals is more critical. The working point of the current source transistor 54 changes with light conditions, and this may slightly influence the drive characteristics.

The examples of the invention use n-type transistors only, but the same circuit operation can be achieved using p-type transistors or a combination of both types.

The detailed design of the display device has not been described in detail, or the control circuitry required to implement control of the pixels. These will be achieved using standard implementation techniques, and the invention resides in the pixel design and control as described above.

From reading the present disclosure, other modifications will be apparent to persons skilled in the art.

1. An active matrix display device comprising an array of display pixels provided over a common substrate, each pixel comprising:
a voltage-programmed current source circuit (52);
a drive transistor (22);
a current-driven light emitting display element (2) driven by the drive transistor; and
a light sensitive device (27) for sensing the display element light output,
wherein the light sensitive device (27) provides a current dependent on the display element output, wherein the light sensitive device (27) and the current source circuit (52) define a feedback control loop which controls the voltage provided to the gate of the drive transistor (22).

2. A device as claimed in claim 1, wherein the light sensitive device (27) comprises a photodiode.

3. A device as claimed in claim 1, wherein the drive transistor (22) and the display element (2) are in series between power lines (26,30).

4. A device as claimed in claim 1, wherein the current source circuit (52) comprises a current source transistor (54), and further comprises a data storage capacitor (C_{data}) for holding a gate voltage of the current source transistor.

5. A device as claimed in claim 4, wherein each pixel further comprises an address transistor (16) between a data input (6) to the pixel and the gate of the current source transistor (54).

6. A device as claimed in claim 4, wherein the source of the current source transistor (54) and the output of the light sensitive device (27) are connected to the gate of the drive transistor (22).

7. A device as claimed in claim 4 wherein each pixel comprises a reset transistor (56) between a reference voltage source (Vref) and the gate of the drive transistor (22).

8. A device as claimed in claim 4, wherein the data storage capacitor (V_{data}) is provided between the gate and source of the current source transistor (54).

9. A device as claimed in claim 1, wherein the feedback control loop is arranged to control the drive transistor (22) gate voltage such that the light sensitive device (27) current and the current source circuit (52) output current are equal.

10. A device as claimed in claim 1, wherein each pixel further comprises a second light sensitive element (60), and wherein the feedback control loop is arranged to control the drive transistor (22) gate voltage such that the difference between the light sensitive device currents and the current source circuit (52) output current are equal.

11. A device as claimed in claim 10, wherein the first and second light sensitive elements (27,60) each comprise substantially identical photodiodes.

12. A device as claimed in claim 10, wherein the second light sensitive element (60) is exposed to ambient light but is shielded from the display element light output.

13. A device as claimed in claim 10, wherein the current source circuit (52) comprises a current source transistor (54), and wherein the second light sensitive element (60) is provided electrically in parallel with the current source transistor (54).

14. A device as claimed in claim 4, wherein the current source circuit further comprises a second storage capacitor (70), the data storage capacitor (C_{data}) and the second storage capacitor (70) being in series between the gate and source of the current source transistor.

15. A device as claimed in claim 14, wherein each pixel comprises a reset transistor (56) between a reference voltage source (Vref) and the junction between the data storage capacitor (C_{data}) and the second storage capacitor (70).

16. A device as claimed in claim 14, wherein the second storage capacitor (70) is for storing a voltage derived from the light sensitive device output for ambient light conditions.

17. A method of driving an active matrix display device comprising an array of display pixels provided over a common substrate, comprising, for each pixel:
driving one end of a data storage capacitor (C_{data}) to a reference voltage (Vref);
driving the other end of the data storage capacitor (C_{data}) to a data voltage;
driving a current source circuit (52) using the voltage across the data storage capacitor (C_{data});
using the current source circuit output to change the gate voltage of a drive transistor (22), and thereby to turn on a light emitting display element (2);
sensing the display element light output using a light sensitive device (27) which provides a current dependent on the display element output; and
combining the light sensitive device (27) current and the current source circuit (52) current to control the voltage provided to the gate of the drive transistor (22).

18. A method as claimed in claim 17, wherein the light sensitive device (27) current and the current source circuit (52) current flow to a common node (Vp) which is connected to the gate of the drive transistor (22) and to the other end of the data storage capacitor (C_{data}).

19. A method as claimed in claim 17, wherein combining the light sensitive device (27) current and the current source circuit (52) current controls the drive transistor (22) gate voltage such that the light sensitive device current and the current source circuit output current are equal.

20. A method as claimed in claim 17, further comprising using a second light sensitive element (60) for detecting ambient light, and wherein combining the light sensitive device (27) current and the current source circuit (52) current to control the voltage provided to the gate of the drive transistor further comprises combining the second light sensitive device (60) current.

21. A method as claimed in claim 20, wherein combining the light sensitive device (27) and second light sensitive device (60) currents and the current source circuit (52) current controls the drive transistor (22) gate voltage such that a difference between the light sensitive device currents and the current source circuit output current are equal.

22. A method as claimed in claim 17, further comprising storing a voltage derived from the light sensitive device output for ambient light conditions on a second storage capacitor (70).
